(19) United States
(12) Patent Application Publication
(10) Pub. No.: US 2006/0192016 A1
(43) Pub. Date: Aug. 31, 2006

(54) Compact personal storage accessory

(76) Inventor: Nicholas Michael Becker, Shorewood, MN (US)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/065,895

(22) Filed: Feb. 25, 2005

(51) Int. Cl. G06K 7/00

(52) U.S. Cl. 235/486

(57) ABSTRACT

A personal storage accessory is disclosed for the efficient storage of personal effects related to personal finances. The personal storage accessory includes a first panel attached to a second panel. The first panel has a length and width that only slightly depart from the length and width of a typical credit card. At least one pocket is attached to a surface of the first panel. The at least one pocket is configured to accommodate insertion of a credit card sized card. The personal storage accessory also includes a register engaged to one of the first and second panels. The register has a length and width that is equal to or less than the length and width of the first panel. The register has a plurality of pages for recording financial transactions.

### BACKGROUND OF THE INVENTION

The present invention relates to a personal storage accessory. In particular, the present invention pertains to a compact wallet for storing items related to personal financial transactions.

Wallets generally store personal effects such as money, photos and credit cards, as well as other miscellaneous cards containing personal information. A driver's license, library cards and insurance cards are examples of miscellaneous cards. To store personal effects, wallets are specially configured to accommodate various items. In particular, wallets often include areas sized to hold financial cards, photos, licenses and money (both change and bills). Therefore, wallets tend to be rather large especially if all the discussed personal effects are stored in a single wallet.

Some wallets are sized to contain a check book. However, with the advancement of new payment technologies, personal checks are being used less and less in financial transactions. In fact, many businesses will no longer accept a personal check as a form of payment. In place of personal checks, individuals have begun using debit cards. A debit card is a card that can act both as a cash card for retrieving money and as a credit card for making credit-type purchases. Unlike a credit card, the debit card will often be configured to facilitate automatic debits against an individual's checking account. Individuals have also begun paying their bills, such as utility bills and mortgage payments, over the Internet. To accomplish Internet bill paying, individuals will enter their checking account number or credit card number into a secured website and their checking account will be automatically debited.

With the decreasing use of personal checks to complete financial transactions, individuals generally do not carry a check book register. It is very easy for individuals to lose track of debits, such as purchases and withdrawals, made from their checking account.

### SUMMARY OF THE INVENTION

The present invention includes a personal storage accessory for the efficient storage of personal effects related to personal finances. The personal storage accessory includes a first panel attached to a second panel. The first panel has a length and width that only slightly depart from the length and width of a typical credit card. At least one pocket is attached to a surface of the first panel. The at least one pocket is configured to accommodate insertion of a credit card sized card. The personal storage accessory also includes a register engaged to one of the first and second panels. The register has a length and width that is equal to or less than the length and width of the first panel. The register has a plurality of pages for recording financial transactions.

### BRIEF DESCRIPTION OF THE DRAWINGS

FIG. 1 illustrates a perspective view of a personal storage accessory in accordance with an embodiment of the present invention.

FIG. 2 illustrates a perspective view of a personal storage accessory in accordance with an embodiment of the present invention.

FIG. 3 illustrates a perspective view of a personal storage accessory in accordance with an embodiment of the present invention.

### DETAILED DESCRIPTION OF THE PREFERRED EMBODIMENTS

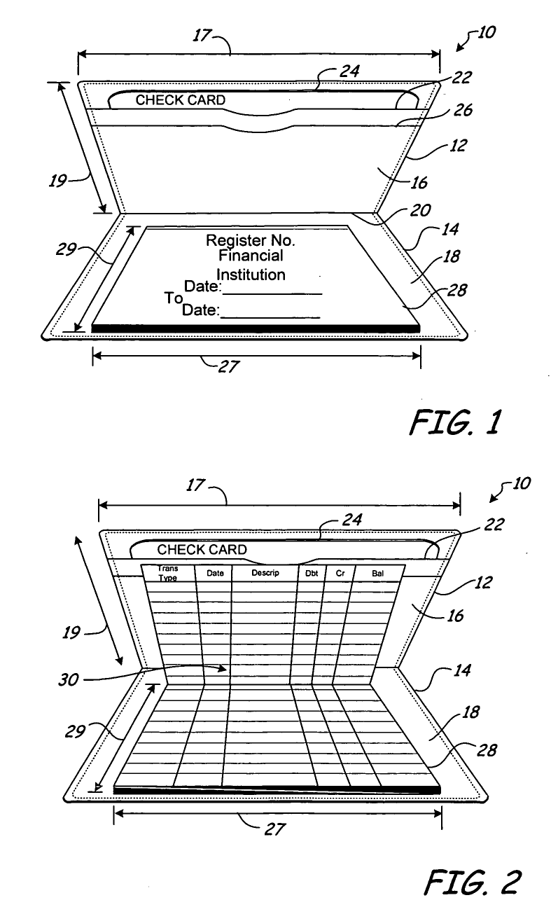

FIGS. 1 and 2 illustrate a personal storage accessory 10 in an open position in accordance with an embodiment of the present invention. Personal storage accessory 10 has at least one panel. As illustrated the at least one panel includes a first panel 12 and a second panel 14. First panel 12 includes an outer surface (not shown in FIG. 1) and an inner surface 16. First panel 12 has a length 17 and a width 19 that is sized to substantially correspond with (or be slightly larger than) a length and a width of a credit card. Second panel 14 includes an outer surface (not shown) and an inner surface 18. Second panel 14 has substantially the same length and width as first panel 12 and is sized to substantially correspond with (or be slightly larger than) the length and the width of a credit card. Second panel 16 is attached to first panel 12 by a fold 20 such that inner surface 16 of first panel 12 faces inner surface 18 of second panel 14 in a closed position. Personal storage accessory 10 includes at least one pocket 22 attached to either inner surface 16 or inner surface 18. In FIGS. 1 and 2, at least one pocket 22 is attached to inner surface 16 of first panel 12. The at least one pocket 22 is configured to accommodate a credit card sized card 24. For example, credit card sized card 24 can include a debit card for making ATM (automatic teller machine) transactions, such as withdrawals, stamp purchases or deposits, or making checking account purchases. Personal storage accessory also includes a receipt pocket 26 attached to either inner surface 16 or inner surface 18. In FIGS. 1 and 2, receipt pocket 26 is attached to inner surface 16 of first panel 12. Receipt pocket 26 is configured to accommodate receipts related to financial transactions. For example, receipts can include ATM withdrawal and deposit slips, purchase receipts or bill paying receipts. Although not illustrated in FIGS. 1 and 2, personal storage accessory 10 can also include additional pockets for accommodating credit cards issued by credit card companies and other types of important credit card sized cards, such as membership cards. Those skilled in the art should recognize that what is stored in these pockets can include items not specifically mentioned.

Personal storage accessory includes a register 28 attached to either inner surface 16 or inner surface 18. In FIGS. 1 and 2, register 28 is attached to inner surface 18 of second panel 14. As illustrated in more detail in FIG. 2, register 28 includes a plurality of transaction lines 30 for keeping a record of transactions made with credit card sized card 24. Transaction lines 30 are blank lines that are to be filled in by a user of personal storage accessory 10. For example, register 28 can include columns related to transaction type, date, description of the transaction, debit amount, credit amount and balance. Those skilled in the art will recognize that other types of columns can be included. Register 28 is sized to fit within personal storage accessory 10. Therefore, register 28 has a length 27 and a width 29 that is similar to a length a width of credit card sized card 24.

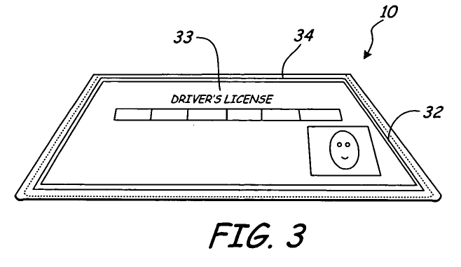

FIG. 3 illustrates a perspective view of personal storage accessory 10 in a closed position or folded position in accordance with an embodiment of the present invention. Outer surface 32 of first panel 12 or outer surface (not shown) of second panel 14 includes a transparent pocket 34. In FIG. 3, transparent pocket 34 is attached to outer surface 32 of first panel 12 and is configured to accommodate an identification card 33, such as an individual's driver's license.

The general size of credit card sized card 24 or other type of credit card is approximately 3⅜ inches by 2⅛ inches. The first and second panels 12 and 14 can have length 17 and width 19 that substantially corresponds to the approximate size of a credit card. However, in one embodiment, first and second panels 12 and 14 do not have a length 17 that is greater than 5 inches nor width 19 that is greater than 3 inches. In particular, first and second panels 12 and 14 do not have a length or a width that is greater than the size of a back pocket in a pair of jeans. These size constraints allow an individual to keep a register or record of financial transactions made to a particular credit card sized card, such as a debit card, and still be able to store the register and the credit sized card easily.

Although the present invention has been described with reference to preferred embodiments, workers skilled in the art will recognize that changes may be made in form and detail without departing from the spirit and scope of the invention.

What is claimed is:

1. A personal storage accessory for the efficient storage of personal effects related to personal finances, the personal storage accessory comprising:
a first panel that is attached to a second panel and includes a length and a width that only slightly depart from the length and a width of a common credit card;
at least one pocket attached to the first panel, the at least one pocket being configured to accommodate insertion of a credit card sized card; and
a register engaged to one of the first and second panels and having a length and a width that is equal or less than the length and width of the first panel, wherein the register includes a plurality of pages for recording financial transactions.

2. The personal storage accessory of claim 1, wherein said at least one pocket comprises two pockets.

3. The personal storage accessory of claim 1, wherein said at least one pocket comprises three pockets.

4. The personal storage accessory of claim 1, wherein said first and second panel each include an outer surface and an inner surface, wherein the second panel is attached to the first panel by a fold such that the inner surface of the first panel can be laid against the inner surface of the second panel.

5. The personal storage accessory of claim 1, further comprising a receipt pocket attached to a surface associated with one of the first and second panels.

6. The personal storage accessory of claim 1, further comprising a transparent pocket attached to a surface associated with one of the first and second panels.

7. The personal storage accessory of claim 1, wherein the register is engaged to the first panel.

8. The personal storage accessory of claim 1, wherein the register is engaged to the second panel.

9. The personal storage accessory of claim 1, wherein the length of the first panel does not exceed 5 inches and the width of the first panel does not exceed 3 inches.

10. A personal storage device comprising:
a piece of material having a pocket engaged thereto, the pocket being configured to receive a card having an overall size and shape similar to those associated with a common credit card; and
a register engaged to the piece of material and having a width that is less than an inch greater than the width of a common credit card.

11. The personal storage device of claim 10, wherein the register has no length or width greater than 5 inches.

12. The personal storage device of claim 10, further comprising a receipt storage compartment incorporated into the piece of material.

13. A personal storage device comprising:
a piece of material having a pocket engaged thereto, the pocket being configured to receive a card having an overall size and shape similar to those associated with a common credit card; and
a register engaged to the piece of material and having a width that is less than an inch greater than the width of the pocket.

14. The personal storage device of claim 13, further comprising an additional pocket engaged to the piece of material.

15. The personal storage device of claim 13, further comprising two additional pockets engaged to the piece of material.

16. The personal storage device of claim 13, wherein the piece of material includes a flexible portion along which it can be folded in half.

17. The personal storage device of claim 13, further comprising a receipt pocket attached to the piece of material.

18. The personal storage device of claim 13, further comprising a transparent pocket attached to the piece of material.

19. The personal storage device of claim 13, wherein when the piece of material is folded in half the device has no length or width greater than 5 inches.

20. The personal storage device of claim 13, wherein the register has no length or width greater than 5 inches.
